(19) United States
(12) Patent Application Publication
(10) Pub. No.: US 2020/0024788 A1
(43) Pub. Date: Jan. 23, 2020

(54) INTELLIGENT VIBRATION PREDICTING METHOD, APPARATUS AND INTELLIGENT COMPUTING DEVICE

(71) Applicant: LG ELECTRONICS INC., Seoul (KR)

(72) Inventor: Dongsoo CHOUNG, Seoul (KR)

(21) Appl. No.: 16/586,230

(22) Filed: Sep. 27, 2019

(30) Foreign Application Priority Data
Aug. 30, 2018 (KR) 10-2019-0107793

(51) Int. Cl. D06F 37/20; D06F 33/02; G06N 3/08

(52) U.S. Cl. CPC D06F 37/203; D06F 33/02; D06F 2202/065; D06F 2202/12; G06N 3/08

(57) ABSTRACT

An intelligent vibration prediction method and apparatus are disclosed. An intelligent vibration prediction method according to an embodiment of the present disclosure inputs washing machine operation data to an input deviation correction model, acquires corrected washing machine operation data from the input deviation correction model, inputs the corrected washing machine operation data to a vibration prediction model, and acquires vibration prediction data from the vibration prediction model, thereby configuring a vibration prediction model optimized for an actual use environment. One or more of the vibration prediction method, the intelligent computing device and the server of the present disclosure can be associated with artificial intelligence (AI) modules, unmanned aerial vehicle (UAV) robots, augmented reality (AR) devices, virtual reality (VR) devices, 5G service related devices, etc.

### CROSS-REFERENCE TO RELATED APPLICATION(S)

This application is based on and claims priority under 35 U.S.C. 119 to Korean Patent Application No. 10-2019-0107793, filed on Aug. 30, 2019, in the Korean Intellectual Property Office, the disclosure of which is herein incorporated by reference in its entirety.

### BACKGROUND OF THE INVENTION

### Field of the Invention

The present disclosure relates to an intelligent vibration predicting method, apparatus and intelligent computing device and, more specifically, to an intelligent vibration predicting method, apparatus and intelligent computing device for predicting vibration in an actual use environment.

### Related Art

In general, a washing machine refers to an apparatus for processing cloth by applying physical and/or chemical actions to laundry such as clothes and bedclothes. A washing machine includes an outer tub in which wash water is contained and an inner tub having cloth contained therein and rotatably installed in the outer tub. A washing method of a normal washing machine includes a process of rotating the inner tub to wash cloth, a process of wring out the cloth using the centrifugal force of the inner tub, and a process of applying heat to dry the cloth.

Severe vibration during a dry process may cause inconvenience of a user, and thus there is a need for a method for accurately predicting vibration through a vibration prediction model.

### SUMMARY OF THE INVENTION

An object of the present disclosure is to meet the needs and solve the problems.

Further, an object of the present disclosure is to realize an intelligent vibration prediction method, apparatus and intelligent computing device for predicting vibration of a washing machine more accurately in an actual use environment.

An intelligent vibration prediction method according to an embodiment of the present disclosure includes: inputting washing machine operation data to an input deviation correction model; acquiring corrected washing machine operation data from the input deviation correction model; inputting the corrected washing machine operation data to a vibration prediction model; and acquiring vibration prediction data from the vibration prediction model.

The washing machine operation data may include at least one piece of data of cRPM, rRPM, Iq, UB and a 6-axis sensor value.

The intelligent vibration prediction method may further include learning the vibration prediction model on the basis of a data set related to a current environment.

The intelligent vibration prediction method may further include updating the input deviation correction model through an external server.

The intelligent vibration prediction method may include: transmitting the washing machine operation data to the external server; receiving parameters of an input deviation correction model learned on the basis of operation data of a plurality of devices including a vibration prediction apparatus from the external server; updating the input deviation correction model using the parameters of the input deviation correction model; and correcting the washing machine operation data using the updated input deviation correction model.

The intelligent vibration prediction method may further include receiving downlink control information (DCI) used to schedule transmission of the washing machine operation data from a network, and transmitting the washing machine operation data to the network on the basis of the DCI.

The intelligent vibration prediction method may further include performing an initial access procedure with respect to the network on the basis of a synchronization signal block (SSB), and transmitting the washing machine operation data to the network through a PUSCH, wherein the SSB and a DM-RS of the PUSCH are QCLed for QCL type D.

The intelligent vibration prediction method may further include controlling a communication unit to transmit the washing machine operation data to an AI processor included in the network, and controlling the communication unit to receive AI processed information from the AI processor, wherein the AI processed information is parameters of the input deviation correction model updated on the basis of the washing machine operation data.

An intelligent vibration prediction apparatus according to an embodiment of the present disclosure includes: at least one sensor, a communication unit, and a processor, wherein the processor is configured to input washing machine operation data to an input deviation correction model, to acquire corrected washing machine operation data from the input deviation correction model, to input the corrected washing machine operation data to a vibration prediction model and to acquire vibration prediction data from the vibration prediction model.

The washing machine operation data may include at least one piece of data of cRPM, rRPM, Iq, UB and a 6-axis sensor value.

The processor may be configured to learn the vibration prediction model on the basis of a data set related to a current environment.

The processor may be configured to update the input deviation correction model through an external server.

The processor may be configured to transmit the washing machine operation data to the external server through the communication unit, to receive parameters of an input deviation correction model learned on the basis of operation data of a plurality of devices including the vibration prediction apparatus from the external server through the communication unit, to update the input deviation correction model using the parameters of the input deviation correction model, and to correct the washing machine operation data using the updated input deviation correction model.

The processor may be configured to receive downlink control information (DCI) used to schedule transmission of the washing machine operation data from a network through the communication unit and to transmit the washing machine operation data to the network on the basis of the DCI through the communication unit.

The processor may be configured to perform an initial access procedure with respect to the network through the communication unit on the basis of a synchronization signal block (SSB) and to transmit the washing machine operation data to the network over a PUSCH through the communication unit, wherein the SSB and a DM-RS of the PUSCH are QCLed for QCL type D.

The processor may be configured to control the communication unit to transmit the washing machine operation data to an AI processor included in the network and to control the communication unit to receive AI processed information from the AI processor, wherein the AI processed information is parameters of the input deviation correction model updated on the basis of the washing machine operation data.

A non-transitory computer readable recording medium according to another embodiment of the present disclosure is a non-transitory computer readably recording medium storing a computer executable component configured to be executed in one or more processors of a computing device, wherein the computer executable component is configured to input washing machine operation data to an input deviation correction model, to acquire corrected washing machine operation data from the input deviation correction model, to input the corrected washing machine operation data to a vibration prediction model, and to acquire vibration prediction data from the vibration prediction model.

An intelligent vibration prediction method, apparatus and intelligent computing device according to an embodiment of the present disclosure have the following effects.

The present disclosure can accurately predict vibration caused by operation of a washing machine in an environment in which an actual user uses the washing machine.

Further, it is possible to maintain consistency of a vibration prediction model between different environments by correcting washing machine operation data values in an actual use environment different from a development environment in which the vibration prediction model has been generated.

It will be appreciated by persons skilled in the art that the effects that could be achieved with the present disclosure are not limited to what has been particularly described hereinabove and the above and other effects that the present disclosure could achieve will be more clearly understood from the following detailed description.

### BRIEF DESCRIPTION OF THE DRAWINGS

The accompanying drawings, included as part of the detailed description in order to provide a thorough understanding of the present disclosure, provide embodiments of the present disclosure and together with the description, describe the technical features of the present disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 is a block diagram of an AI device according to an embodiment of the present disclosure.

FIG. 5 is a flowchart illustrating a vibration prediction method according to an embodiment of the present disclosure.

FIG. 6 illustrates a vibration prediction model and peripheral components according to an embodiment of the present disclosure.

FIG. 7 illustrates an artificial neural network structure when a product is launched/evolved according to an embodiment of the present disclosure.

FIG. 8 illustrates a process of updating an input deviation correction model through a server according to an embodiment of the present disclosure.

FIG. 9 illustrates a first/second model update process according to an embodiment of the present disclosure.

FIG. 10 is a flowchart illustrating a process of learning an input deviation correction model through a network (server).

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

### A. Example of Block Diagram of UE and 5G Network

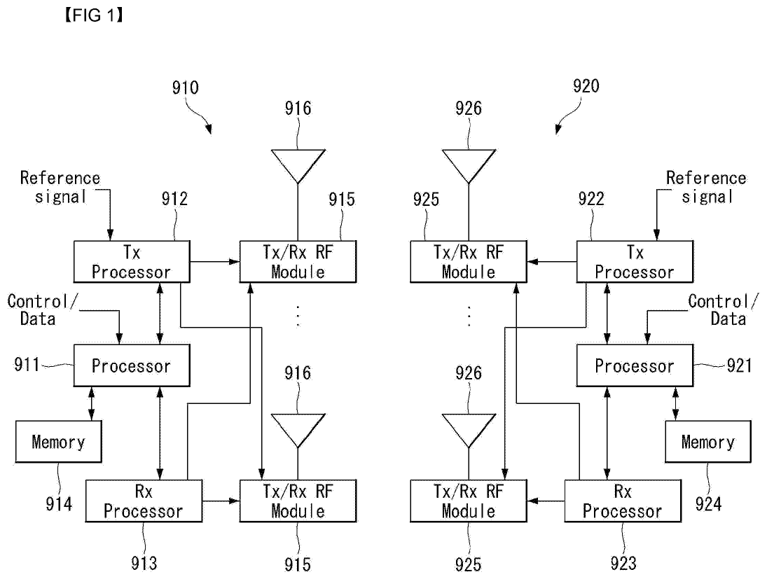

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device(AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

[symbol]

### B. Signal Transmission/Reception Method in Wireless Communication System

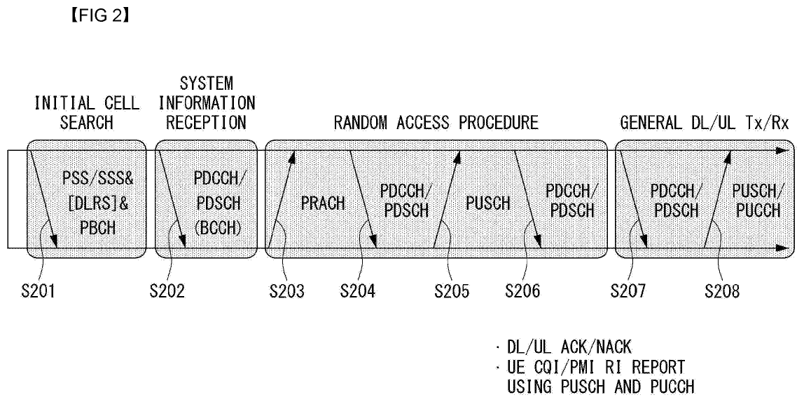

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtaind through an SSS of the cell, and information on the cell ID among 336 cell ID groups is provided/obtaind through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a

PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

[symbol]

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.

The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

[symbol]

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

[symbol]

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionlnDCl by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

[symbol]

### E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

[symbol]

### F. Basic Operation of AI Processing Using 5G Communication

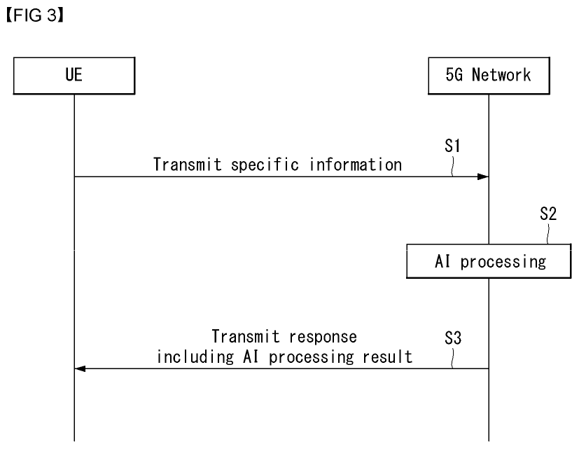

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE(S3).

[symbol]

### G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

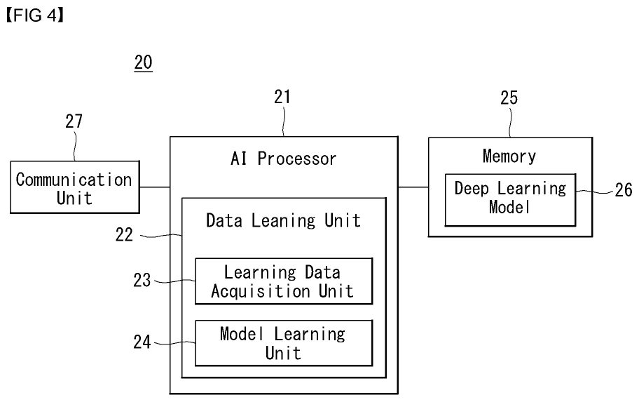

FIG. 4 is a block diagram of an AI device according to an embodiment of the present disclosure.

The AI device 20 may include an electronic device including an AI module that can perform AI processing, a server including the AI module, or the like. Further, the AI device 20 may be included as a component of the device 10 illustrated in FIG. 4 to perform at least a part of AI processing.

The AI processing may include all operations related to driving of the device 10 illustrated in FIG. 4. For example, an autonomous vehicle can perform AI processing on sensing data or driver data for processing/determination and control signal generation operations. Further, for example, the autonomous vehicle can perform autonomous driving control by performing AI processing on data acquired through interaction with other electronic devices included in the vehicle.

The AI device 20 may include an AI processor 21, a memory 25 and/or a communication unit 27.

The AI device 20 is a computing device that can learn a neural network and may be implemented as various electronic devices such as a server, a desktop PC, a notebook PC and a tablet PC.

The AI processor 21 can learn a neural network using a program stored in a memory 25. Particularly, the AI processor 21 can learn a neural network for recognizing device related data. Here, the neural network for recognizing device related data can be designed to simulate the structure of the human brain on a computer and include a plurality of network nodes having weights and simulating neurons of the human neural network. The plurality of network nodes can exchange data according to connection relation therebetween to simulate the synaptic activity of neurons which exchanges signals through synapse. Here, the neural network may include a deep learning model developed from a neural network model. In the deep learning model, the plurality of network nodes is located at different layers and can exchange data according to a convolution connection relation. Examples of the neural network include various deep learning techniques such as deep neural networks (DNNs), convolutional deep neural networks (CNNs), recurrent Boltzmann machine, restricted Boltzmann machine (RBM), deep belief networks (DBN), deep Q-network and may be applied to computer vision, speech recognition, natural language processing, audio/signal processing, and the like.

While a processor which executes the aforementioned functions can be a general-purpose processor (e.g., CPU), it may be an AI dedicated processor (e.g., GPU) for artificial intelligence learning.

The memory 25 can store various programs and data necessary for operation of the AI device 20. The memory 25 may be implemented as a non-volatile memory, a volatile memory, a flash memory, a hard disk drive (HDD), a solid state drive (SDD), or the like. The memory 25 can be accessed by the AI processor 21 and reading/recording/correction/deletion/update of data can be performed therein by the AI processor 21. Further, the memory 25 can store a neural network model (e.g., a deep learning model 26) generated through a learning algorithm for data classification/recognition according to an embodiment of the present disclosure.

Further, the AI processor 21 may include a data learning unit 22 for learning a neural network for data classification/recognition. The data learning unit 22 can learn standards for learning data to be used to determine data classification/recognition and methods of classifying and recognizing data using the learning data. The data learning unit 22 can learn a deep learning model by acquiring learning data to be used for learning and applying the acquired learning data to the deep learning model.

The data learning unit 22 can be manufactured in the form of at least one hardware chip and mounted in the AI device 20. For example, the data learning unit 22 may be manufactured in the form of a hardware chip dedicated for artificial intelligence (AI) or manufactured as a part of a general-purpose processor (CPU) or a graphic-only processor (GPU) and mounted in the AI device 20. Further, the data learning unit 22 may be implemented as a software module. When the data learning unit 22 is implemented as a software module (or a program module including instructions), the software module may be stored in non-transitory computer readable media. In this case, at least one software module may be provided by an operating system (OS) or an application.

The data learning unit 22 may include a learning data acquisition unit 23 and a model learning unit 24.

The learning data acquisition unit 23 can acquire learning data necessary for a neural network model for classifying and recognizing data. For example, the learning data acquisition unit 23 can acquire vehicle data and/or sample data to be input to the neural network model as learning data.

The model learning unit 24 can learn the neural network model to have criteria for how to classify predetermined data using the acquired learning data. Here, the model learning unit 24 can learn the neural network model through supervised learning using at least a part of the learning data as criteria. Alternatively, the model learning unit 24 can learn the neural network model through unsupervised learning by which criteria are discovered through unsupervised learning using learning data. Further, the model learning unit 24 can learn the neural network model through reinforcement learning using feedback for whether a situation determination result according to learning is correct. Further, the model learning unit 24 can learn the neural network model using a learning algorithm including error back-propagation or gradient decent.

When the neural network model is learned, the model learning unit 24 can store the learned neural network model in the memory. The model learning unit 24 may store the learned neural network model in a memory of a server connected to the AI device 20 in a wired or wireless manner.

The data learning unit 22 may further include a learning data pre-processor (not shown) and a learning data selector (not shown) in order to improve recognition model analysis results or save resources or time necessary to generate a recognition model.

The learning data pre-processor can pre-process acquired data such that the acquired data can be used for learning for situation determination. For example, the learning data pre-processor can process acquired data into a preset format such that the model learning unit 24 can use the acquired data for learning for image recognition.

Further, the learning data selector can select data necessary for learning from learning data acquired by the learning data acquisition unit 23 and learning data pre-processed by the pre-processor. The selected learning data can be provided to the model learning unit 24. For example, the learning data selector can detect a specific region of an image acquired through a camera of a vehicle to select only data with respect to an object included in the specific region as learning data.

Further, the data learning unit 22 may further include a model evaluator (not shown) for improving neural network model analysis results.

The model evaluator can input evaluation data to a neural network model and cause the model learning unit 22 to learn the neural network model again when analysis results output from the evaluation data do not satisfy a predetermined standard. In this case, the evaluation data may be predefined data for evaluating a recognition model. For example, when the number or rate of pieces of evaluation data for which analysis results are not correct from among analysis results of a recognition model learned for the evaluation data exceeds a predetermined threshold value, the model evaluator can evaluate that the analysis results do not satisfy the predetermined standard.

The communication unit 27 can transmit AI processing results obtained by the AI processor 21 to an external electronic device.

Here, the external electronic device can be defined as an autonomous vehicle. Further, the AI device 20 can be defined as another vehicle or a 5G network which communicates with the autonomous vehicle. Meanwhile, the AI device 20 may be implemented by being functionally embedded in an autonomous driving module included in a vehicle. Further, the 5G network may include a server or a module which performs autonomous driving related control.

Although the AI device 20 illustrated in FIG. 4 has separate functional units such as the AI processor 21, the memory 25 and the communication unit 27, the aforementioned components may be integrated into one module and called an AI module.

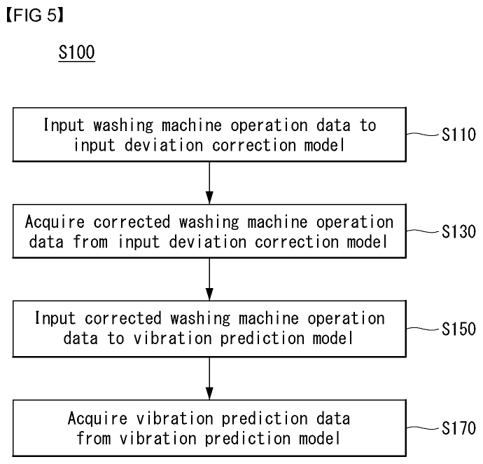

FIG. 5 is a flowchart illustrating a vibration prediction method according to an embodiment of the present disclosure.

As illustrated in FIG. 5, according to an embodiment of the present disclosure, a vibration prediction apparatus can input washing machine operation data to an input deviation correction model S110.

The washing machine operation data may include at least one piece of data of cRPM, rRPM, Iq, UB and a 6-axis sensor value.

However, washing machine operation data before correction is different for actual use environments according to product deviations (damper, spring and motor performances, etc.). Further, washing machine operation data before correction is different for actual use environments according to actual use environment deviations (power quality, floor material, floor inclination, temperature, humidity, etc.).

Here, the vibration prediction apparatus may be the AI device 20 described with reference to FIG. 4.

Subsequently, the vibration prediction apparatus can acquire corrected washing machine operation data from the input deviation correction model (S130).

Then, the vibration prediction apparatus can input the corrected washing machine operation data to a vibration prediction model (S150).

Thereafter, the vibration prediction apparatus can acquire vibration prediction data from the vibration prediction model (S170).

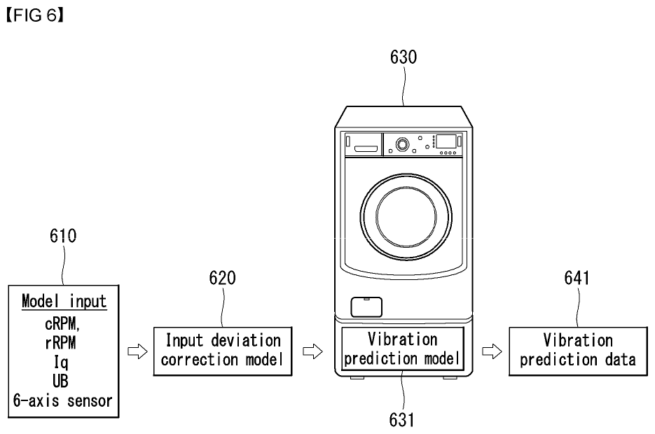

FIG. 6 illustrates a vibration prediction model and peripheral components according to an embodiment of the present disclosure.

As illustrated in FIG. 6, the vibration prediction apparatus may correct a model input 610 (washing machine operation data) by inputting the model input 610 to an input deviation correction model 620 in order to input the model input 610 to a vibration prediction model.

Thereafter, the vibration prediction apparatus may input the corrected model input (washing machine operation data) to a vibration prediction model 631 of a washing machine 630.

Then, the vibration prediction apparatus may acquire vibration prediction data 641 as an output value of the vibration prediction model.

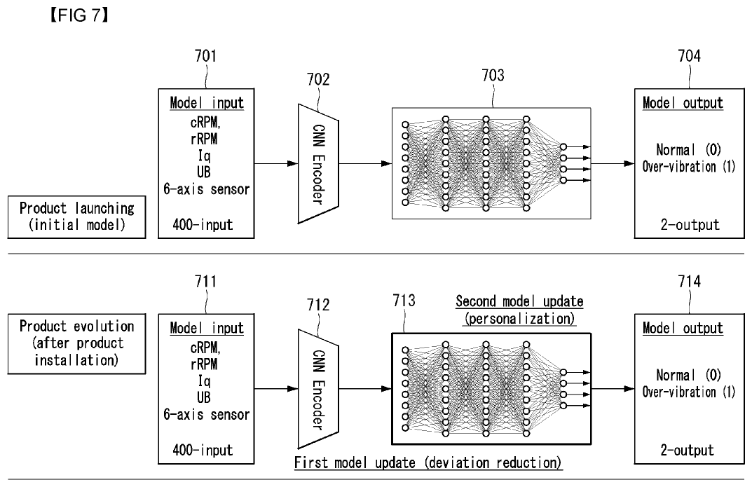

FIG. 7 illustrates an artificial neural network structure when a product is launched/evolved according to an embodiment of the present disclosure.

As illustrated in FIG. 7, the vibration prediction apparatus may input an output value obtained by a model input 701 to a CNN encoder 702 to a vibration prediction model 703 and acquire a model output (normal (0) and over-vibration (1), 2-output) 704 as an output value in a product launching (initial model) stage.

Thereafter, the vibration prediction apparatus may input a model input 711 to a CNN encoder 712 to perform first model update (for reducing a deviation), update (for personalization) a vibration prediction model 713 using an output value of the CNN encoder 713, and acquire a model output 714 as an output value in a product evolution (after product installation) stage.

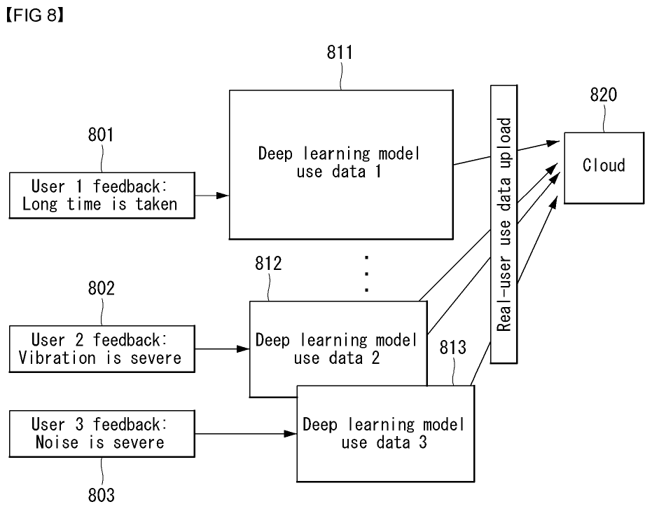

FIG. 8 illustrates a process of updating an input deviation correction model through a sever according to an embodiment of the present disclosure.

As illustrated in FIG. 8, a plurality of vibration prediction apparatuses may transmit real-user use data, such as deep learning model use data 1 811, deep learning model use data 2 812 and deep learning model use data 3 813 along with a user 1 feedback (“a long time is taken”) 801, a user 2 feedback (“vibration is severe”) 802 and a user 3 feedback (“noise is severe”) 803 to a cloud (server) 820.

The cloud may update the input deviation correction model on the basis of the transmitted real-user use data.

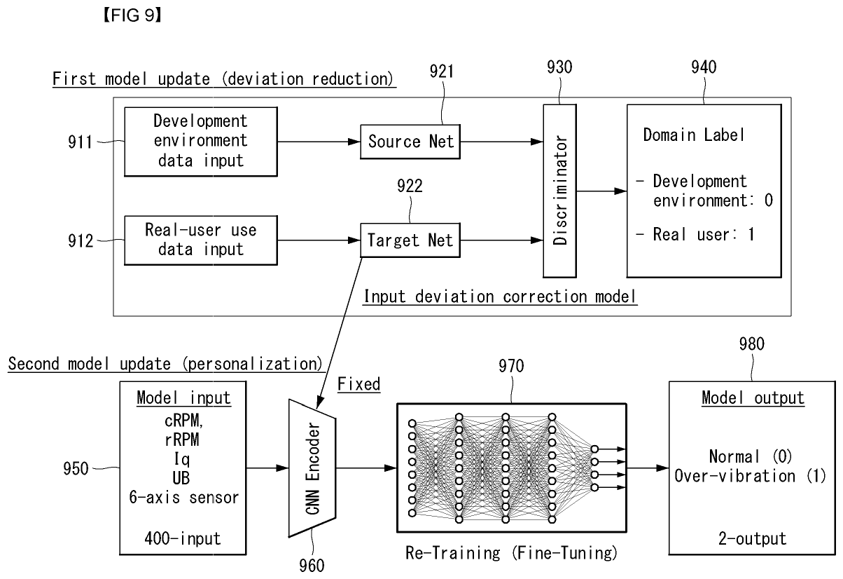

FIG. 9 illustrates a first/second model update process according to an embodiment of the present disclosure.

As illustrated in FIG. 9, a vibration prediction apparatus 10 can perform first model update. Here, the first model update may be a process of updating an input deviation correction model for removing a deviation in washing machine operation data.

For example, the vibration prediction apparatus may input a development environment data input 911 to a source net 921 and input a real-user use data input 912 to a target net 922. Here, the target net may be an input deviation correction model.

Then, the vibration prediction apparatus may input an output value obtained by inputting the development environment data input 911 to the source net 921 and an output value obtained by inputting the real-user use data input 912 to the target net 922 to a discriminator 930.

The vibration prediction apparatus may acquire a domain label (development environment: 0, real user: 1) 940 as an output value of the discriminator.

Thereafter, the vibration prediction apparatus may perform second model update. Here, the second model update may refer to a process of updating a vibration prediction model which outputs vibration data from washing machine operation data to a vibration prediction model optimized for an actual use environment.

First, the vibration prediction apparatus may input model inputs 950 to a CNN encoder 960. Here, the CNN encoder may be the same as the target net of the first model update.

Subsequently, the vibration prediction apparatus may input an output value of the CNN encoder to a vibration prediction model 970 to perform re-training (file-tuning).

Thereafter, the vibration prediction apparatus may acquire “model output/2 outputs of normal (0) and over-vibration (1)” 980 as an output value of the vibration prediction model.

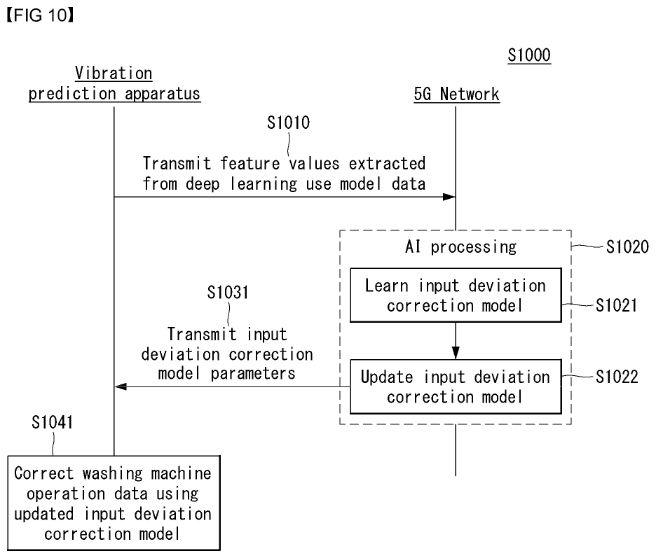

FIG. 10 is a flowchart illustrating a process of learning an input deviation correction model through a 5G network (server).

First, the vibration prediction apparatus 10 or the processor 170 of the vibration prediction apparatus may control a communication unit 110 such that the communication unit 110 transmits feature values extracted from detected washing machine operation data to an AI processor included in a 5G network. Further, the processor 170 may control the communication unit such that the communication unit receives AI processed information from the AI processor.

The AI processed information may include parameters of an updated input deviation correction model.

Further, the processor 170 may perform an initial access procedure with respect to the 5G network in order to transmit the washing machine operation data to the 5G network. The processor 170 may perform the initial access procedure with respect to the 5G network on the basis of a synchronization signal block (SSB).

Further, the processor 170 may receive downlink control information (DCI) used to schedule transmission of the washing machine operation data from the network through a wireless communication unit.

The processor 170 may transmit the washing machine operation data to the network on the basis of the DCI.

The processor 170 may transmit the washing machine operation data to the network through a PUSCH, and the SSB and a DM-RS of the PUSCH may be QCLed for QCL type D.

Subsequently, the vibration prediction apparatus 10 may transmit the feature values extracted from the washing machine operation data to the 5G network (S1010).

Here, the 5G network may include an AI processor or an AI system, and the AI system of the 5G network can perform AI processing on the basis of the received washing machine operation data (S1020).

First, the AI system may learn an input deviation correction model using the feature values of the washing machine operation data received from the vibration prediction apparatus 10 (S1021).

The AI system may update the input deviation correction model on the basis of the washing machine operation data (S1022). The 5G network may transmit parameters of the input deviation correction model updated in the AI system to the vibration prediction apparatus 10 through a communication unit (S1031).

The vibration prediction apparatus may correct the washing machine operation data using the updated input deviation correction mode (S1041).

Embodiment 1: an intelligent vibration prediction method includes: inputting washing machine operation data to an input deviation correction model; acquiring corrected washing machine operation data from the input deviation correction model; inputting the corrected washing machine operation data to a vibration prediction model; and acquiring vibration prediction data from the vibration prediction model.

Embodiment 2: in embodiment 1, the washing machine operation data includes at least one piece of data of cRPM, rRPM, Iq, UB and a 6-axis sensor value.

Embodiment 3: in embodiment 2, the intelligent vibration prediction method further includes learning the vibration prediction model on the basis of a data set related to a current environment.

Embodiment 4: in embodiment 1, the intelligent vibration prediction method further includes updating the input deviation correction model through an external server.

Embodiment 5: in embodiment 4, the intelligent vibration prediction method includes: transmitting the washing machine operation data to the external server; receiving parameters of an input deviation correction model learned on the basis of operation data of a plurality of devices including a vibration prediction apparatus from the external server; updating the input deviation correction model using the parameters of the input deviation correction model; and correcting the washing machine operation data using the updated input deviation correction model.

Embodiment 6: in embodiment 1, the intelligent vibration prediction method further includes receiving downlink control information (DCI) used to schedule transmission of the washing machine operation data from a network, and transmitting the washing machine operation data to the network on the basis of the DCI.

Embodiment 7: in embodiment 6, the intelligent vibration prediction method further includes performing an initial access procedure with respect to the network on the basis of a synchronization signal block (SSB), and transmitting the washing machine operation data to the network through a PUSCH, wherein the SSB and a DM-RS of the PUSCH are QCLed for QCL type D.

Embodiment 8: in embodiment 6, the intelligent vibration prediction method further includes controlling a communication unit to transmit the washing machine operation data to an AI processor included in the network, and controlling the communication unit to receive AI processed information from the AI processor, wherein the AI processed information is parameters of the input deviation correction model updated on the basis of the washing machine operation data.

Embodiment 9: an intelligent vibration prediction apparatus includes: at least one sensor, a communication unit, and a processor, wherein the processor is configured to input washing machine operation data to an input deviation correction model, to acquire corrected washing machine operation data from the input deviation correction model, to input the corrected washing machine operation data to a vibration prediction model and to acquire vibration prediction data from the vibration prediction model.

Embodiment 10: in embodiment 9, the washing machine operation data includes at least one piece of data of cRPM, rRPM, Iq, UB and a 6-axis sensor value.

Embodiment 11: in embodiment 10, the processor learns the vibration prediction model on the basis of a data set related to a current environment.

Embodiment 12: in embodiment 9, the processor is configured to update the input deviation correction model through an external server.

Embodiment 13: in embodiment 12, the processor is configured to transmit the washing machine operation data to the external server through the communication unit, to receive parameters of an input deviation correction model learned on the basis of operation data of a plurality of devices including the vibration prediction apparatus from the external server through the communication unit, to update the input deviation correction model using the parameters of the input deviation correction model, and to correct the washing machine operation data using the updated input deviation correction model.

Embodiment 14: in embodiment 9, the processor is configured to receive downlink control information (DCI) used to schedule transmission of the washing machine operation data from a network through the communication unit and to transmit the washing machine operation data to the network on the basis of the DCI through the communication unit.

Embodiment 15: in embodiment 14, the processor is configured to perform an initial access procedure with respect to the network through the communication unit on the basis of a synchronization signal block (SSB) and to transmit the washing machine operation data to the network over a PUSCH through the communication unit, wherein the SSB and a DM-RS of the PUSCH are QCLed for QCL type D.

Embodiment 16: in embodiment 14, the processor is configured to control the communication unit to transmit the washing machine operation data to an AI processor included in the network and to control the communication unit to receive AI processed information from the AI processor, wherein the AI processed information is parameters of the input deviation correction model updated on the basis of the washing machine operation data.

Embodiment 17: a non-transitory computer readable recording medium storing a computer executable component configured to be executed in one or more processors of a computing device, wherein the computer executable component is configured to input washing machine operation data to an input deviation correction model, to acquire corrected washing machine operation data from the input deviation correction model, to input the corrected washing machine operation data to a vibration prediction model, and to acquire vibration prediction data from the vibration prediction model.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. An intelligent vibration prediction method comprising:
inputting washing machine operation data to an input deviation correction model;
acquiring corrected washing machine operation data from the input deviation correction model;
inputting the corrected washing machine operation data to a vibration prediction model; and
acquiring vibration prediction data from the vibration prediction model.

2. The intelligent vibration prediction method of claim 1, wherein the washing machine operation data includes at least one piece of data of cRPM, rRPM, Iq, UB and a 6-axis sensor value.

3. The intelligent vibration prediction method of claim 2, wherein further comprising learning the vibration prediction model on the basis of a data set related to a current environment.

4. The intelligent vibration prediction method of claim 1, further comprising updating the input deviation correction model through an external server.

5. The intelligent vibration prediction method of claim 4, comprising:
transmitting the washing machine operation data to the external server;
receiving parameters of an input deviation correction model learned on the basis of operation data of a plurality of devices including a vibration prediction apparatus from the external server;
updating the input deviation correction model using the parameters of the input deviation correction model; and
correcting the washing machine operation data using the updated input deviation correction model.

6. The intelligent vibration prediction method of claim 1, further comprising:
receiving downlink control information (DCI) used to schedule transmission of the washing machine operation data from a network; and
transmitting the washing machine operation data to the network on the basis of the DCI.

7. The intelligent vibration prediction method of claim 6, further comprising:
performing an initial access procedure with respect to the network on the basis of a synchronization signal block (SSB); and
transmitting the washing machine operation data to the network through a PUSCH,
wherein the SSB and a DM-RS of the PUSCH are QCLed for QCL type D.

8. The intelligent vibration prediction method of claim 6, further comprising:
controlling a transceiver to transmit the washing machine operation data to an AI processor included in the network; and
controlling the transceiver to receive AI processed information from the AI processor,
wherein the AI processed information is parameters of the input deviation correction model updated on the basis of the washing machine operation data.

9. An intelligent vibration prediction apparatus comprising:
at least one sensor;
a transceiver; and
a processor,
wherein the processor is configured:
to input washing machine operation data to an input deviation correction model;
to acquire corrected washing machine operation data from the input deviation correction model;
to input the corrected washing machine operation data to a vibration prediction model; and
to acquire vibration prediction data from the vibration prediction model.

10. The intelligent vibration prediction apparatus of claim 9, wherein the washing machine operation data includes at least one piece of data of cRPM, rRPM, Iq, UB and a 6-axis sensor value.

11. The intelligent vibration prediction apparatus of claim 10, wherein the processor is configured to learn the vibration prediction model on the basis of a data set related to a current environment.

12. The intelligent vibration prediction apparatus of claim 9, wherein the processor is configured to update the input deviation correction model through an external server.

13. The intelligent vibration prediction apparatus of claim 12, wherein the processor is configured:
to transmit the washing machine operation data to the external server through the transceiver;
to receive parameters of an input deviation correction model learned on the basis of operation data of a plurality of devices including the vibration prediction apparatus from the external server through the transceiver;
to update the input deviation correction model using the parameters of the input deviation correction model; and
to correct the washing machine operation data using the updated input deviation correction model.

14. The intelligent vibration prediction apparatus of claim 9, wherein the processor is configured:
to receive downlink control information (DCI) used to schedule transmission of the washing machine operation data from a network through the transceiver; and
to transmit the washing machine operation data to the network on the basis of the DCI through the transceiver.

15. The intelligent vibration prediction apparatus of claim 14, wherein the processor is configured:
to performs an initial access procedure with respect to the network through the transceiver on the basis of a synchronization signal block (SSB); and
to transmit the washing machine operation data to the network over a PUSCH through the transceiver,
wherein the SSB and a DM-RS of the PUSCH are QCLed for QCL type D.

16. The intelligent vibration prediction apparatus of claim 14, wherein the processor is configured:
to control the transceiver to transmit the washing machine operation data to an AI processor included in the network; and
to control the transceiver to receive AI processed information from the AI processor,
wherein the AI processed information is parameters of the input deviation correction model updated on the basis of the washing machine operation data.

17. A non-transitory computer readable recording medium storing a computer executable component configured to be executed in one or more processors of a computing device,
wherein the computer executable component configured:
to input washing machine operation data to an input deviation correction model;
to acquire corrected washing machine operation data from the input deviation correction model;
to input the corrected washing machine operation data to a vibration prediction model; and
to acquire vibration prediction data from the vibration prediction model.
